(19) United States
(12) Patent Application Publication
(10) Pub. No.: US 2002/0056954 A1
(43) Pub. Date: May 16, 2002

(54) Device for fixation of a workpiece

(76) Inventors: Kurt Schmalz, Dornstetten (DE); Thomas Eisele, Fluorn-Winzeln (DE); Ralf Stockburger, Glatten (DE)

Correspondence Address: William M. Hanlon, Jr., Young & Basile, P.C., Suite 624, 3001 West Big Beaver Road, Troy, MI, 48084, US

(21) Appl. No.: 10/036,816

(22) Filed: Oct. 19, 2001

(30) Foreign Application Priority Data
Oct. 20, 2000 (DE) 100 52 276.9

(51) Int. Cl. B25B 11/00

(52) U.S. Cl. 269/21

(57) ABSTRACT

A device for fixation of sheet-like workpieces with a vacuum holding block and a fixture rail, where the vacuum holding block can be shifted by means of a carrier riding movably in the fixture rail and the motive forces are transmitted magnetically from the carrier to the vacuum holding block.

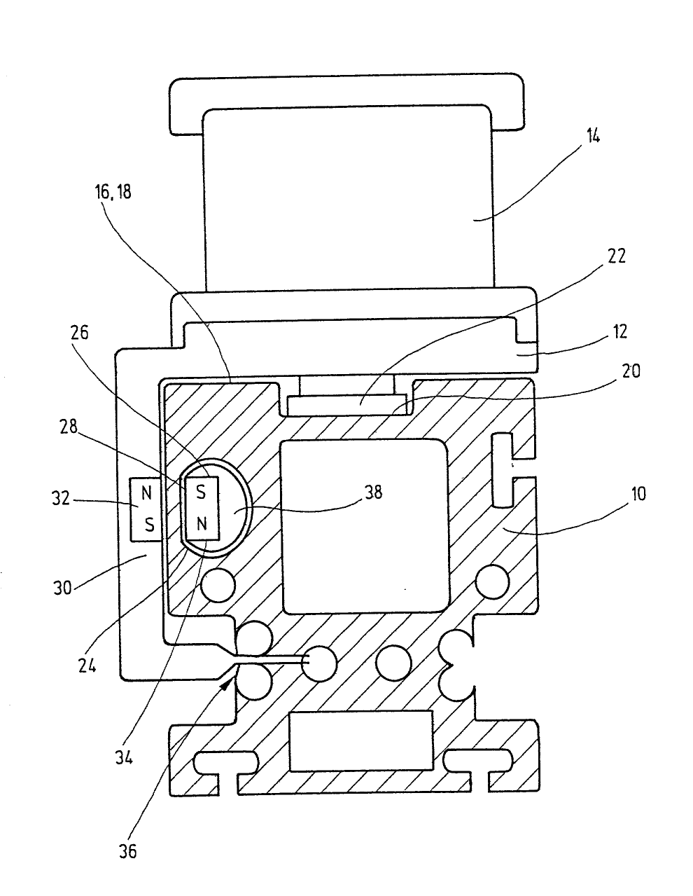

### BACKGROUND

The invention relates to a device for the fixation of workpieces, specifically of sheet-like workpieces, with at least one fixture unit and at least one vacuum holding block mounted on the fixture unit, as well as a drive to transport the vacuum holding block on the fixture unit, where the drive is provided at the fixture unit.

From DE-U-94 19 700, a machine tool is known having vacuum fixturing for sheet-like workpieces, in which the vacuum fixtures are located on guide rails. The vacuum fixtures are positioned along the guide rail by means of a movable pin. This device requires a positioning unit with which each individual vacuum fixture has to be moved and then positioned. A construction of this kind is expensive.

It would be desirable to further develop a device for the fixation of workpieces in such a way that the vacuum holding blocks can be positioned quickly and in a relatively simple way.

### SUMMARY

The invention is a device of the type described above, whereby the drive has a carrier, the carrier is furnished with a magnetic or magnetizable material, the vacuum holding block itself, or an element connected to the vacuum holding block, is furnished with a magnetic or magnetizable material in an area facing the fixture unit and referenced to the carrier, and the vacuum holding block or the element is carried on a longitudinal guide.

With the device according to the invention, the considerable advantage is obtained that it is possible to move the vacuum holding block contact-free, that is to say, the vacuum holding block and the driven carrier are not connected to each other. This has the considerable advantage that the vacuum holding blocks can first of all be exchanged relatively quickly because they no longer have to be released from the carrier. An additional advantage can be seen in the fact that the carrier can be driven by any method, and specifically in the case of hydraulic or pneumatic drives no seals are required because the carrier has no mechanical connection with the vacuum holding block or its element, respectively. The longitudinal guide has the task of carrying the vacuum holding block so that the areas furnished with the magnetic or magnetizable material always remain referenced to each other. The transmission of power is carried out solely by means of the magnetic forces from the carrier to the vacuum holding block, or to its element, respectively.

The fixture unit is preferably configured as a fixture rail or as a fixture table. In the case of the fixture rail, the vacuum holding blocks are shifted in the longitudinal direction of the rail, whereas in the case of the fixture table the vacuum holding blocks are shifted in rows lying parallel to one another.

In a further development, the invention provides the fixture unit with at least one passage and the carrier configured as a piston which rides movably in the passage, specifically in the longitudinal direction of the fixture rail. The piston can be secured against rotation. This has the considerable advantage that by applying pressure or vacuum respectively to the passage, the carrier, or the piston, can be moved without difficulty inside the passage and by means of magnetic forces carries the vacuum holding block seated on the fixture unit or the fixture rail respectively. Of course the fixture unit or the fixture rail consists of a non-magnetizable material, for example, aluminum. Securing the piston against rotation prevents the area of the carrier furnished with a magnetic or magnetizable material from moving away from the vacuum holding block as the result of rotation of the piston.

The piston preferably has a flat, where the flat is oriented in the direction of the area of the vacuum holding block possessing the magnetic or magnetizable material, or in the direction of the element connected to it. The positioning of the magnetic or magnetizable material on a flat surface has the considerable advantage that substantially higher forces can be generated, because the clearance to the vacuum holding block, or the magnetic or magnetizable material referenced to it, can be kept very small. Through suitable coding of the magnets, both on the carrier side and on the vacuum holding block side, the carrier forces can be increased even further.

Another aspect provides for the carrier to be driven by means of a piston rod or a belt. When a belt is used, the path of the vacuum holding block does not have to be absolutely linear, but can also have non-linearities, for example, the path can be curved.

In another aspect, the intention is for the carrier to be part of a drive motor which meshes with a rack or similar element, which is connected to the fixture unit. This means that the carrier only has to be provided with an energy supply, and that no other forces have to be transmitted to the carrier. The carrier itself moves to the desired position and carries the vacuum holding block with it by means of the magnetic forces.

In a further development, the intent is to configure the element attached to the vacuum holding block as a carriage. This carriage is located either solely on the top side of the fixture unit or surrounds it partially or completely. In the case of a fixture rail, the carriage can be movably carried either solely on its top side or the carriage can have an L-shape or a U-shape and partially surround the fixture rail.

### BRIEF DESCRIPTION OF THE DRAWING

Additional advantages, features and details of the invention can be derived from the following description, in which a particularly preferred embodiment is described in detail with reference to the drawing. The features shown in the drawing as well as those mentioned in the claims and in the description can be essential to the invention either individually or in any combination. The drawing shows a cross section through a particularly preferred embodiment of the invention.

### DETAILED DESCRIPTION

The drawing shows a fixture rail identified overall as 10, which is manufactured by extrusion and consists of aluminum, as well as a carriage 12 with a vacuum holding block 14 seated thereon. The fixture rail 10, and with it the fixture unit 18, has a central longitudinal channel 20 on its top side 16, into which a longitudinal guide 22 is installed. The carriage 12 is carried on the longitudinal guide 22, which ensures that the carriage 12 always has the same orientation with respect to the fixture rail 10, except for its position in the longitudinal direction (vertical drawing plane). The longitudinal rail 22 is designed in such a way that the carriage 12 can be shifted in the longitudinal direction of the fixture rail 10 with minimum application of force.

The fixture rail 10 is provided with a multiplicity of openings, passages and grooves which serve to locate means to secure the fixture rail to a machine bed and to mount other objects to the fixture rail 10. One passage 24 is configured as a pneumatic or hydraulic passage and serves to carry a piston 26, which rides movably in the longitudinal direction as well. The piston 26 has a flat 28, which is facing in the direction of one leg 30 of the carriage 12. This leg 30 encloses the fixture rail 10 in the area of the passage 24, and on the side facing the fixture rail 10 is, the leg 30 furnished with a magnetic or magnetizable material 32. The flat 28 is referenced to this material 32, while the flat 28 also carries a magnetic or magnetizable material 34.

In the case of the embodiment shown, for example, a magnet 32 is installed in the carriage to which a magnet installed in the flat 28 or a magnetizable material 34 is disposed adjacent thereto. The magnet poles positioned facing each other have opposite polarities. The result of this arrangement of the magnets 32, 34 is that the piston 26, which is driven by pneumatic or hydraulic force, carries the magnet opposite and thus the carriage 12 with the vacuum holding block 14 and shifts them on the longitudinal guide 22 relative to the fixture rail 10. No involvement with the fixture rail 10 is necessary to move or position the vacuum holding block 14, which requires complex sealing. The piston 26 therefore acts as a carrier 38 for the vacuum holding block 14.

The introduction of vacuum to tighten the vacuum holding block 14 on the carriage 12 and to tighten a workpiece, which is not shown, on the vacuum holding block 14 can be accomplished, for example, by a merely schematically represented tap 36.

What is claimed is:

1. Device for fixation of workpieces, specifically of sheet-like workpieces, with at least one fixture unit (18) and at least one vacuum holding block (14) mounted on the fixture unit (18) as well as a drive to transport and position the vacuum holding block (14) on the fixture unit (18), where the drive is connected to the fixture unit (18), characterized in that the drive has a carrier (38), that the carrier (38) is equipped with a magnetic or magnetizable material (34), that the vacuum holding block (14), or an element (leg 30) connected to the vacuum holding block (14), is furnished with a magnetic or magnetizable material (32) in an area facing the fixture (18) and referenced to the carrier and that the vacuum holding block (14) or the element rides on a longitudinal guide (22).

2. Device in accordance with claim 1, wherein the fixture is provided with at least one passage (24) and wherein the carrier (38) is configured as a piston (26) and rides movably in the passage (24).

3. Device in accordance with claim 2, wherein the piston (26) is secured against rotation.

4. Device in accordance with claim 2 or 3, wherein the piston (26) has a flat (28), where the flat (28) is facing in the direction of the area of the vacuum holding block containing the magnetic or magnetizable material (32) or of the element (leg 30) connected to this vacuum holding block.

5. Device in accordance with one of the claims 2 to 4, wherein the piston (26) can be driven pneumatically or hydraulically.

6. Device in accordance with claim 4 or 5, wherein the flat (28) is furnished with the magnetic or magnetizable material (34).

7. Device in accordance with claim 1, wherein the carrier (38) can be driven by means of a piston rod or a belt.

8. Device in accordance with claim 1, wherein the carrier (38) is part of a drive motor which meshes with a rack or similar connected to the fixture unit (18).

9. Device in accordance with one of the preceding claims, wherein the element connected to the vacuum holding block is configured as a carriage (12).

10. Device in accordance with one of the preceding claims, wherein the fixture unit is formed by a fixture rail (14) or a fixture table.

11. Device in accordance with one of the preceding claims, wherein the drive for the vacuum holding block or for the element (leg 30) connected to the vacuum holding block (14) takes place without contact.
